(19) United States
(12) Patent Application Publication
(10) Pub. No.: US 2026/0292465 A1
(43) Pub. Date: Sep. 24, 2026

(54) WIRELESS COMMUNICATIONS WITH AMBIENT INTERNET OF THINGS DEVICES

(71) Applicant: QUALCOMM Incorporated, San Diego, CA (US)

(72) Inventors: Luanxia YANG, Beijing (CN); Xiaojie WANG, Hillsborough, NJ (US); Junyi LI, Greentown, PA (US); Xiaoxia ZHANG, San Diego, CA (US); Jing SUN, San Diego, CA (US)

(21) Appl. No.: 19/477,160

(22) PCT Filed: Jun. 23, 2023
(86) PCT No.: PCT/CN2023/102003

§ 371 Date: Oct. 21, 2025

(51) Int. Cl. H04W 8/00; H04L 5/00; H04W 60/04; H04W 72/0453; H04W 72/12

(52) U.S. Cl. CPC H04W 8/005; H04L 5/0053; H04W 60/04; H04W 72/0453; H04W 72/12

(57) ABSTRACT

Wireless communications systems, apparatuses, and methods are provided. A method of wireless communication performed by a first user equipment (UE) includes transmitting, to one or more ambient Internet of Things (IoT) devices in resources scheduled by a wireless communication device, a discovery signal to initiate an association procedure between the first UE and at least one of the one or more ambient IoT devices, and receiving, from the one or more ambient IoT devices in response to the discovery signal, an acknowledgment to initiate the association procedure, wherein the one or more ambient IoT devices are powered by energy transmitted by the wireless communication device.

### TECHNICAL FIELD

This application relates to wireless communication systems, and more particularly, to improving wireless communications between ambient Internet of Things (IoT) devices and other wireless communication devices, including communications between an ambient IoT device and a user equipment (UE).

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power).

Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

To meet the growing demands for expanded mobile broadband connectivity, wireless communication technologies are advancing from the LTE technology to a next generation NR technology. For example, NR is expanding to enhanced mobile broadband (eMBB), e.g., ultra-reliable low latency communications (URLLC) and machine type communication (MTC). NR may be extended to support passive Internet of Things (IoT), e.g., supporting radio frequency identification (RFID) sensors in use cases.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In an aspect of the disclosure, a method of wireless communication performed by a first user equipment (UE) may include transmitting, to one or more ambient Internet of Things (IoT) devices in resources scheduled by a wireless communication device, a discovery signal to initiate an association procedure between the first UE and at least one of the one or more ambient IoT devices; and receiving, from the one or more ambient IoT devices in response to the discovery signal, an acknowledgment to initiate the association procedure, wherein the one or more ambient IoT devices are powered by energy transmitted by the wireless communication device.

In an additional aspect of the disclosure, a method of wireless communication performed by an ambient IoT device may include receiving, from a wireless communication device, an indicator indicating resources for transmitting a discovery signal, wherein the ambient IoT device is powered by energy transmitted by the wireless communication device; transmitting, to one or more first UEs in the resources, a discovery signal to initiate an association procedure between the one or more first UEs and the ambient IoT device; and receiving, from at least one of the one or more first UEs in response to the discovery signal, an acknowledgment to initiate the association procedure with the at least one of the one or more first UEs.

In an additional aspect of the disclosure, a method of wireless communication performed by a wireless communication device may include transmitting, to a UE, an indicator indicating resources associated with a discovery signal to initiate an association procedure between the first UE and an ambient IoT device; receiving, from the first UE, an indication of one or more selected resources from the resources associated with the discovery signal; and transmitting, to the ambient IoT device, a continuous wave in the one or more selected resources to power the ambient IoT device during the association procedure.

In an additional aspect of the disclosure, a first UE may include at least one memory; at least one transceiver; and at least one processor in communication with the at least one memory and the at least one transceiver, wherein the first UE is configured to: transmit, to one or more ambient IoT devices in resources scheduled by a wireless communication device, a discovery signal to initiate an association procedure between the first UE and at least one of the one or more ambient IoT devices; and receive, from the one or more ambient IoT devices in response to the discovery signal, an acknowledgment to initiate the association procedure, wherein the one or more ambient IoT devices are powered by energy transmitted by the wireless communication device.

In an additional aspect of the disclosure, an ambient IoT device may include at least one memory; at least one transceiver; and at least one processor in communication with the at least one memory and the at least one transceiver, wherein the ambient IoT device is configured to: receive, from a wireless communication device, an indicator indicating resources for transmitting a discovery signal, wherein the ambient IoT device is powered by energy transmitted by the wireless communication device; transmit, to one or more first UEs in the indicated resources, a discovery signal to initiate an association procedure between the one or more first UEs and the ambient IoT device; and receive, from at least one of the one or more first UEs in response to the discovery signal, an acknowledgment to initiate the association procedure with the at least one of the one or more first UEs.

In an additional aspect of the disclosure, a wireless communication device may include at least one memory; at least one transceiver; and at least one processor in communication with the at least one memory and the at least one transceiver, wherein the wireless communication device is configured to: transmit, to a first UE, an indicator indicating resources associated with a discovery signal to initiate an association procedure between the first UE and an ambient IoT device; receive, from the first UE, an indication of one or more selected resources from the resources associated with the discovery signal; and transmit, to the ambient IoT device, a continuous wave in the one or more selected resources to power the ambient IoT device during the association procedure.

Other aspects, features, and instances of the present invention will become apparent to those of ordinary skill in the art, upon reviewing the following description of specific, exemplary instances of the present invention in conjunction with the accompanying figures. While features of the present invention may be discussed relative to certain aspects and figures below, all instances of the present invention may include one or more of the advantageous features discussed herein. In other words, while one or more instances may be discussed as having certain advantageous features, one or more of such features may also be used in accordance with the various instances of the invention discussed herein. In similar fashion, while exemplary aspects may be discussed below as device, system, or method instances it should be understood that such exemplary instances may be implemented in various devices, systems, and methods.

### BRIEF DESCRIPTION OF THE DRAWINGS

FIG. 1 illustrates a wireless communication network according to some aspects of the present disclosure.

FIG. 2 illustrates an example disaggregated base station architecture according to some aspects of the present disclosure.

FIG. 3 illustrates an example wireless communication between an ambient IoT device and a user equipment according to some aspects of the present disclosure.

FIG. 4 is a signal flow diagram of a communication method according to some aspects of the present disclosure.

FIG. 5 is a signal flow diagram of a communication method according to some aspects of the present disclosure.

FIG. 6 is a signal flow diagram of a communication method according to some aspects of the present disclosure.

FIG. 7 is a block diagram of an exemplary user equipment (UE) according to some aspects of the present disclosure.

FIG. 8 is a block diagram of an exemplary ambient Internet of Things (IoT) device according to some aspects of the present disclosure.

FIG. 9 is a block diagram of an exemplary network unit according to some aspects of the present disclosure.

FIG. 10 is a flow diagram of a communication method according to some aspects of the present disclosure.

FIG. 11 is a flow diagram of a communication method according to some aspects of the present disclosure.

FIG. 12 is a flow diagram of a communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various instances, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks, as well as other communications networks. As described herein, the terms “networks” and “systems” may be used interchangeably.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may include at least one element of a claim.

RFID is a rapidly growing technology in many industries because RFID technologies provide high economic potential in the fields of asset management, IoT, sustainable sensor networks, smart home, and the like. RFID may include small transponders emitting an information-bearing signal upon receiving a signal, such that RFID is able to be operated without a battery at low operating expense. As 5G is expanding to more industrial verticals besides eMBB, e.g., URLLC and MTC, 5G and beyond may be expanded to support passive IoT. Therefore, since a backscatter-based device (e.g., a passive ambient IoT device) may communicate with a normal UE, such that a method for a communication between an ambient IoT device and a UE may be considered.

Various aspects relate generally to wireless communication and more particularly to a wireless communication with an ambient IoT device. Some aspects more specifically relate to a wireless communication between an ambient IoT device and a UE, and the ambient IoT device is powered by a wireless communication device, e.g., a third node that is not the UE communicating with the ambient IoT device. In some examples, a third node may be an entity that communicates with (e.g., sending energy signal) the ambient IoT device. For example, the third node may be a wired communication device (e.g., an integrated access and backhaul (IAB) node) and/or a wireless communication device (e.g., a base station or another UE). In some examples, the wireless communication device may send an energy signal to the ambient IoT device via scheduled resources, such that when the UE sends a discovery signal, the ambient IoT device may transmit the acknowledgment back to the UE (e.g., backscattering the discovery signal sent from the UE) to initiate an association with the UE. In some examples, the scheduled resources may be scheduled by the wireless communication device or indicated by the UE. In some examples, the wireless communication device may send the energy signal in a specific energy pattern to assist discovering the ambient IoT device (e.g., a target ambient IoT device). As such, the ambient IoT device may be discovered efficiently, and the association may be performed using the dedicated resources to reduce collision.

Additionally or alternatively, the ambient IoT device may be powered by the wireless communication device and send the discovery signal to the UE. When the UE receives the discovery signal from the ambient IoT device, the UE may transmit the identifier to the ambient IoT device to initiate an association with the ambient IoT device. In some examples, the scheduled resources may be scheduled by the wireless communication device or indicated by the ambient IoT device. In some embodiments, when the wireless communication device may send the energy signal to one or more ambient IoT devices, the wireless communication device may select resources (e.g., divided resources for multiple ambient IoT devices) for transmitting the discovery signal arranged by the wireless communication device or indicated by the ambient devices. Furthermore, when there are one or more UEs responding to the discovery signal, the wireless communication device may divide the resources for the UEs to select one resource to send the response. As such, it can reduce collisions in the association.

Particular aspects of the subject matter described in this disclosure may be implemented to realize one or more of the following potential advantages. In some examples, by implementing wireless communication procedure according to embodiments of the present disclosure, the described techniques may be used to support transmission of RFID sensors in NR technology and improve transmission efficiency in terms of discovering a target ambient IoT device. Furthermore, the described techniques may reduce collisions in associating the ambient IoT devices with the UEs. For example, the wireless communication device may divide resources into different time durations and/or frequency areas, and the ambient IoT devices or the UEs may each select one divided resource for transmission to avoid collisions.

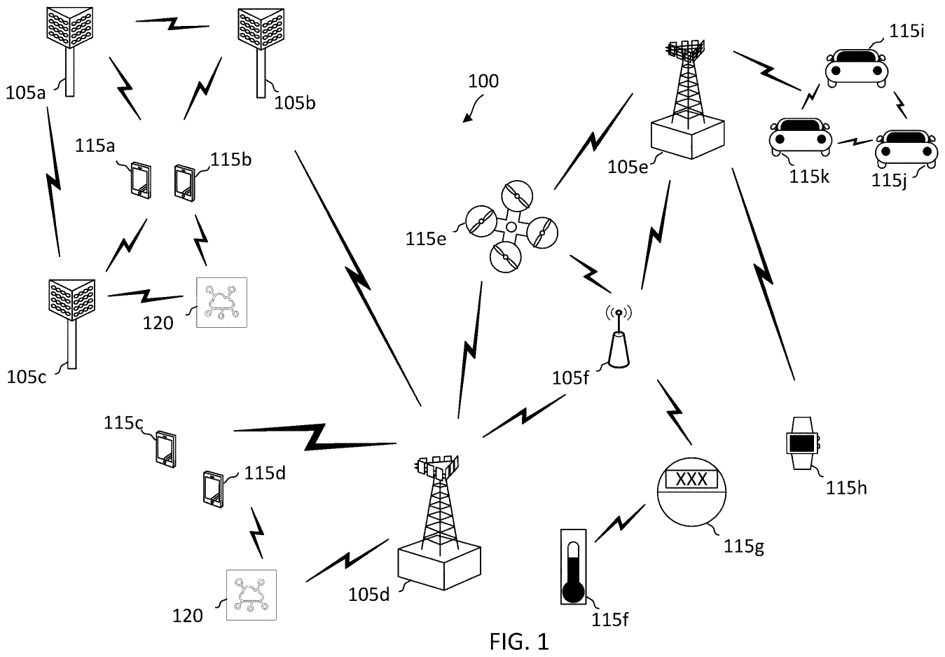

FIG. 1 illustrates a wireless communication network 100 according to some aspects of the present disclosure. The network 100 includes a number of base stations (BSs) 105 and other network entities. In some aspects, a BS 105 may be interchangeable with a network node, and not limited to base stations. A BS 105 may be a station that communicates with UEs 115 and/or an internet of things (IoT) device 120 and may also be referred to as an evolved node B (eNB), a next generation eNB (gNB), an access point, and the like. Each BS 105 may provide communication coverage for a particular geographic area. In 3GPP, the term “cell” may refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 and/or IoT devices 120 may be dispersed throughout the wireless network 100, and each UE 115 and/or IOT device 120 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices 120 or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The IoT devices 120 may include one or more sensors and be configured for communication with a BS 105 and/or a UE 115. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between devices. For example, a lightning bolt mat indicate wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of an evolved NodeB (eNB) or an access node controller (ANC)) may interface with the core network 130 through backhaul links (e.g., S1, S2, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a vehicle (e.g., a car, a truck, a bus, an autonomous vehicle, an aircraft, a boat, etc.). Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), the UE 115h (e.g., wearable device), and the IoT device 120 (e.g., a RFID sensor) may communicate through the network 100 either directly with BSs, such as the small cell BS 105f, and the macro BSs 105d and 105e, or in multi-hop configurations by communicating with another user device which relays its information to the network, such as the UE 115f communicating temperature measurement information to the smart meter, the UE 115g, which is then reported to the network through the small cell BS 105f. In some aspects, the UE 115h may harvest energy from an ambient environment associated with the UE 115h. In some aspects, the IoT device 120 may harvest energy from an ambient environment associated with the IoT device 120. For example, the IoT device 120 may be an ambient IoT device that may harvest energy from the BS 105d or the UE 115d. The network 100 may also provide additional network efficiency through dynamic, low-latency TDD/FDD communications, such as vehicle-to-vehicle (V2V), vehicle-to-everything (V2X), cellular-vehicle-to-everything (C-V2X) communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some instances, the BSs 105 may assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication may be in the form of radio frames. A radio frame may be divided into a plurality of subframes, for example, about 10. Each subframe may be divided into slots, for example, about 2. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes may be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal may have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information-reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some instances, the BSs 105 and the UEs 115 may communicate using self-contained subframes. A self-contained subframe may include a portion for DL communication and a portion for UL communication. A self-contained subframe may be DL-centric or UL-centric. A DL-centric subframe may include a longer duration for DL communication than for UL communication. A UL-centric subframe may include a longer duration for UL communication than for UL communication.

In some instances, the network 100 may be an NR network deployed over a licensed spectrum. The BSs 105 may transmit synchronization signals (e.g., including a primary synchronization signal (PSS) and a secondary synchronization signal (SSS)) in the network 100 to facilitate synchronization. The BSs 105 may broadcast system information associated with the network 100 (e.g., including a master information block (MIB), remaining minimum system information (RMSI), and other system information (OSI)) to facilitate initial network access. In some instances, the BSs 105 may broadcast the PSS, the SSS, and/or the MIB in the form of synchronization signal blocks (SSBs) over a physical broadcast channel (PBCH) and may broadcast the RMSI and/or the OSI over a physical downlink shared channel (PDSCH).

In some instances, a UE 115 attempting to access the network 100 may perform an initial cell search by detecting a PSS from a BS 105. The PSS may enable synchronization of period timing and may indicate a physical layer identity value. The UE 115 may then receive an SSS. The SSS may enable radio frame synchronization, and may provide a cell identity value, which may be combined with the physical layer identity value to identify the cell. The SSS may also enable detection of a duplexing mode and a cyclic prefix length. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical uplink control channel (PUCCH), physical uplink shared channel (PUSCH), power control, SRS, and cell barring.

After obtaining the MIB, the RMSI and/or the OSI, the UE 115 may perform a random access procedure to establish a connection with the BS 105. For the random access procedure, the UE 115 may transmit a random access preamble and the BS 105 may respond with a random access response. Upon receiving the random access response, the UE 115 may transmit a connection request to the BS 105 and the BS 105 may respond with a connection response (e.g., contention resolution message).

After establishing a connection, the UE 115 and the BS 105 may enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The BS 105 may transmit a DL communication signal to the UE 115 via a PDSCH according to a DL scheduling grant. The UE 115 may transmit a UL communication signal to the BS 105 via a PUSCH and/or PUCCH according to a UL scheduling grant.

The network 100 may be designed to enable a wide range of use cases. While in some examples a network 100 may utilize monolithic base stations, there are a number of other architectures which may be used to perform aspects of the present disclosure. For example, a BS 105 may be separated into a remote radio head (RRH) and baseband unit (BBU). BBUs may be centralized into a BBU pool and connected to RRHs through low-latency and high-bandwidth transport links, such as optical transport links. BBU pools may be cloud-based resources. In some aspects, baseband processing is performed on virtualized servers running in data centers rather than being co-located with a BS 105. In another example, based station functionality may be split between a remote unit (RU), distributed unit (DU), and a central unit (CU). An RU generally performs low physical layer functions while a DU performs higher layer functions, which may include higher physical layer functions. A CU performs the higher RAN functions, such as radio resource control (RRC).

For simplicity of discussion, the present disclosure refers to methods of the present disclosure being performed by base stations, or more generally network entities, while the functionality may be performed by a variety of architectures other than a monolithic base station. In addition to disaggregated base stations, aspects of the present disclosure may also be performed by a centralized unit (CU), a distributed unit (DU), a radio unit (RU), a Near-Real Time (Near-RT) RAN Intelligent Controller (RIC), a Non-Real Time (Non-RT) RIC, IAB node, a relay node, a sidelink node, etc.

In some aspects, the UE 115 may transmit, to one or more IoT devices 115 in resources scheduled by a BS 105, a discovery signal to initiate an association procedure between the UE 115 and at least one of the one or more IoT devices 115. The UE 115 may receive, from the one or more IoT devices 115 in response to the discovery signal, an acknowledgment to initiate the association procedure, wherein the one or more IoT devices 115 are powered by energy transmitted by the BS 105.

In some aspects, a first UE 115 may transmit, to one or more ambient IoT devices 120 in resources scheduled by a wireless communication device 105, a discovery signal to initiate an association procedure between the first UE 115 and at least one of the one or more ambient IoT devices 120. The first UE 115 may receive, from the one or more ambient IoT devices 120 in response to the discovery signal, an acknowledgment to initiate the association procedure, wherein the one or more ambient IoT devices 120 are powered by energy transmitted by the wireless communication device 105.

In some aspects, an ambient IoT device 120 may receive, from a wireless communication device 105, an indicator indicating resources for transmitting a discovery signal, wherein the ambient IoT device 120 is powered by energy transmitted by the wireless communication device 105. The ambient IoT device 120 may transmit, to one or more first UEs 115 in the indicated resources, a discovery signal to initiate an association procedure between the one or more first UEs 115 and the ambient IoT device 120. The ambient IoT device 120 may receive, from at least one of the one or more first UEs 115 in response to the discovery signal, an acknowledgment to initiate the association procedure with the at least one of the one or more first UEs 115.

In some aspects, the BS 105 may transmit, to a first UE 115, an indicator indicating resources associated with a discovery signal to initiate an association procedure between the first UE 115 and an ambient IoT device 120. The BS 105 may receive, from the first UE 115, an indication of one or more selected resources from the resources associated with the discovery signal. The BS 105 may transmit, to the ambient IoT device 120, a continuous wave in the one or more selected resources to power the ambient IoT device 120 during the association procedure.

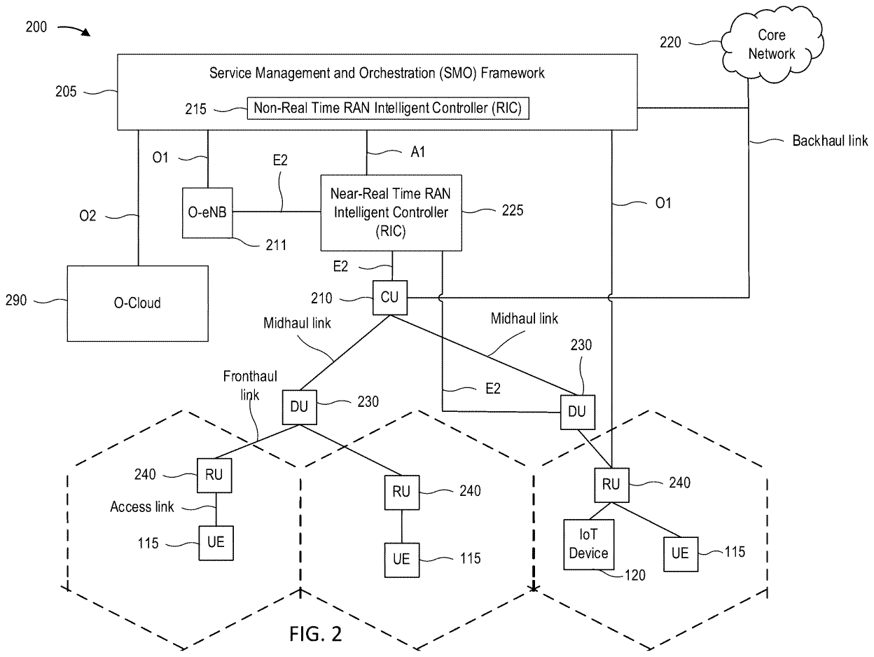

FIG. 2 shows a diagram illustrating an example disaggregated base station 200 architecture. The disaggregated base station 200 architecture may include one or more central units (CUs) 210 that may communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 115 (e.g., the UEs 115a-115j) and/or the IoT devices 120 via one or more radio frequency (RF) access links. In some implementations, the UE 115 may be simultaneously served by multiple RUs 240.

Each of the units, i.e., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 may be logically split into one or more CU-UP units and one or more CU-CP units. The CU-UP unit may communicate bidirectionally with the CU-CP unit via an interface, such as the E1 interface when implemented in an O-RAN configuration. The CU 210 may be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) may be implemented with an interface configured to communicate signals with other layers (and modules) hosted by the DU 230, or with the control functions hosted by the CU 210.

Lower-layer functionality may be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 may be implemented to handle over the air (OTA) communication with one or more UEs 115. In some implementations, real-time and non-real-time aspects of control and user plane communication with the RU(s) 240 may be controlled by the corresponding DU 230. In some scenarios, this configuration may enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements may include CUs 210, DUs 230, RUs 240 and Near-RT RICs 225. In some implementations, the SMO Framework 205 may communicate with a hardware aspect of a 4G RAN, such as an open eNB (O-eNB) 211, via an O1 interface. Additionally, in some implementations, the SMO Framework 205 may communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

In some aspects, the UE 115 may transmit, to one or more IoT devices 120 in resources scheduled by a RU 240, a discovery signal to initiate an association procedure between the UE 115 and at least one of the one or more IoT devices 120. The UE 115 may receive, from the one or more IoT devices 120 in response to the discovery signal, an acknowledgment to initiate the association procedure, wherein the one or more IoT devices 120 are powered by energy transmitted by the RU 240.

In some aspects, a first UE 115 may transmit, to one or more ambient IoT devices 120 in resources scheduled by a RU 240, a discovery signal to initiate an association procedure between the first UE 115 and at least one of the one or more ambient IoT devices 120. The first UE 115 may receive, from the one or more ambient IoT devices 120 in response to the discovery signal, an acknowledgment to initiate the association procedure, wherein the one or more ambient IoT devices 120 are powered by energy transmitted by the RU 240.

In some aspects, an ambient IoT device 120 may receive, from a RU 240, an indicator indicating resources for transmitting a discovery signal, wherein the ambient IoT device 120 is powered by energy transmitted by the RU 240. The ambient IoT device 120 may transmit, to one or more first UEs 115 in the indicated resources, a discovery signal to initiate an association procedure between the one or more first UEs 115 and the ambient IoT device 120. The ambient IoT device 120 may receive, from at least one of the one or more first UEs 115 in response to the discovery signal, an acknowledgment to initiate the association procedure with the at least one of the one or more first UEs 115.

In some aspects, the RU 240 may transmit, to a first UE 115, an indicator indicating resources associated with a discovery signal to initiate an association procedure between the first UE 115 and an ambient IoT device 120. The RU 240 may receive, from the first UE 115, an indication of one or more selected resources from the resources associated with the discovery signal. The RU 240 may transmit, to the ambient IoT device 120, a continuous wave in the one or more selected resources to power the ambient IoT device 120 during the association procedure.

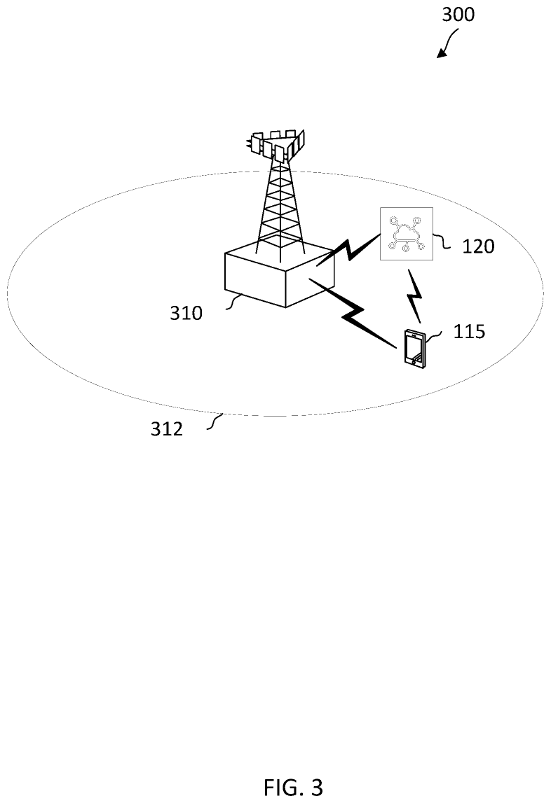

FIG. 3 illustrates an example of wireless communication between an ambient IoT device and a user equipment according to some aspects of the present disclosure. A wireless communication network 300 includes a network unit 310, an ambient IoT device 320, and the UE 115. In some aspects, the network unit 310 may be a BS, a CU, a DU, and/or a RU that communicates with the UE 115. In some aspects, the network unit 310 may be the BS 105, the CU 210, the DU 230, the RU 240 and/or a network unit 900 described in FIG. 1-2, or 9. In some aspects, the network unit 310 may be an integrated access and backhaul (IAB) node, a repeater node, or a gNB. In some aspects, the UE 115 may be the UE 115 or a UE 700 described in FIG. 1, 2, or 7. In some aspects, the ambient IoT device 320 may be the ambient IoT device 120 or an ambient IoT device 800 described in FIG. 1, 2, or 8. The network unit 310 may provide communication coverage for a cell 312. The cell 312 may allow the UE 115 access to its network provider and support the UE 115 and the ambient IoT device 320 to initiate an association procedure. In some aspects, the cell 312 may be cells described in FIG. 1.

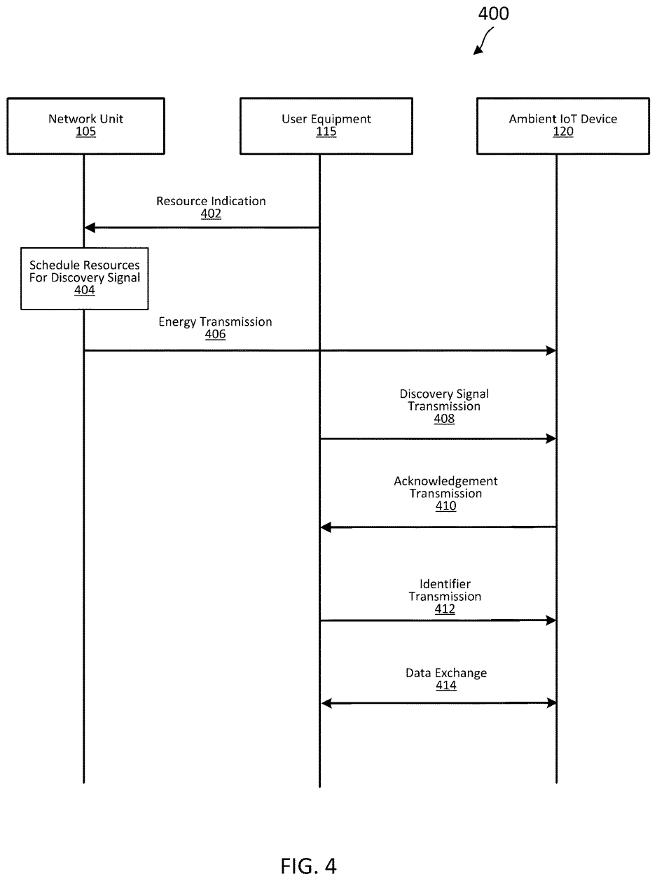

In some aspects, the UE 115 may initiate an association procedure with the ambient IoT device 320 or any other IoT devices within a proximity to the UE 115 and supported by the network unit 310. The UE 115 may transmit a discovery signal to initiate the association procedure. The ambient IoT device 320 may be powered by an energy signal transmitted by the network unit 310 and detect the discovery signal transmitted by the UE 115. The ambient IoT device 320 may decode the discovery signal and transmit a response to the UE 115 to acknowledge receiving the discovery signal to initiate the association procedure with the UE 115. The detailed steps of examples of the UE 115 initiating the association procedure with the ambient IoT device 320 will be further described in FIG. 4.

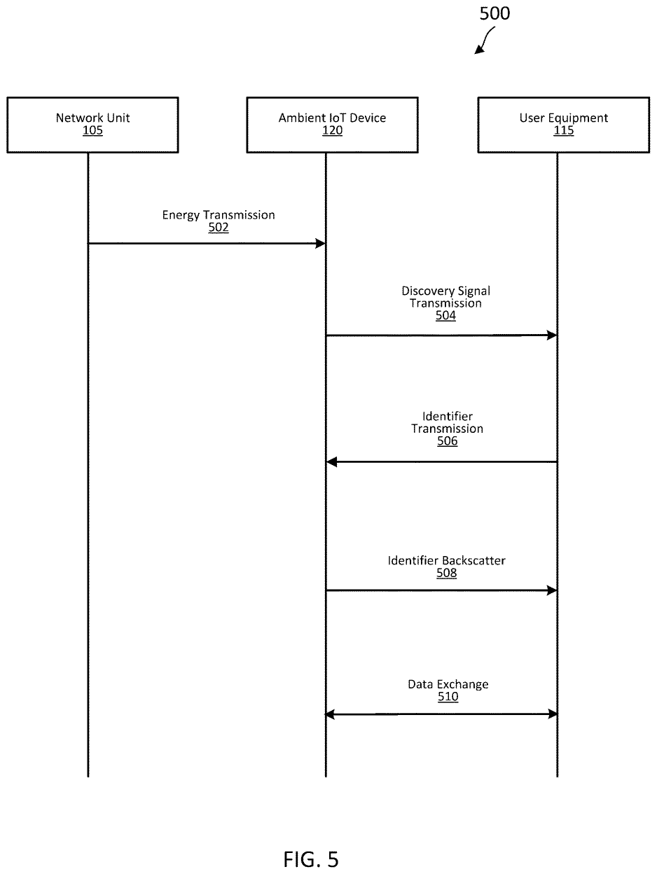

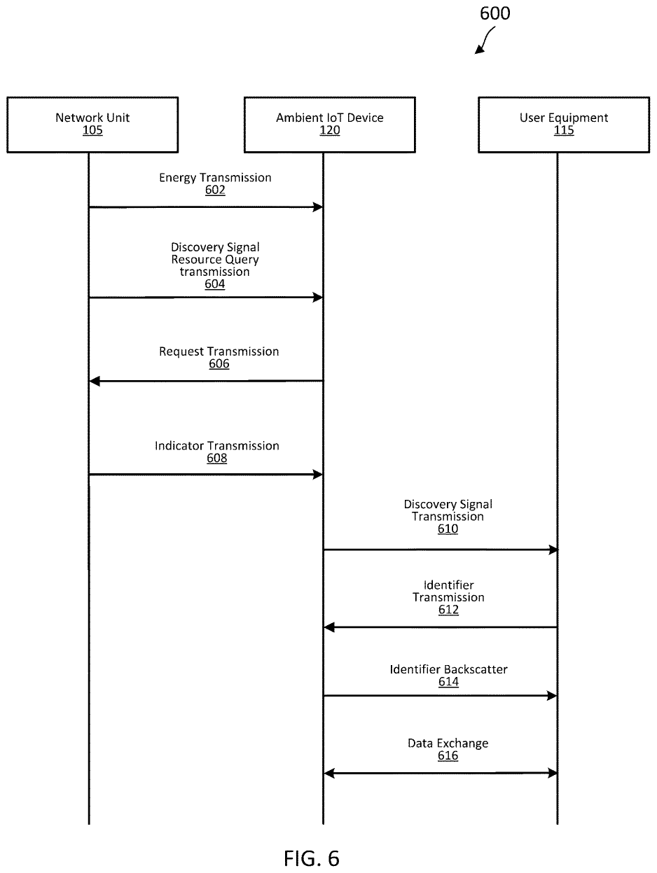

In some aspects, the ambient IoT device 320 may initiate an association procedure with the UE 115 and/or any other UEs within a proximity to the ambient IoT device 320. The ambient IoT device 320 may be powered by an energy signal transmitted by the network unit 310. The ambient IoT device 320 may transmit a discovery signal to initiate the association procedure. The UE 115 may detect the discovery signal transmitted by the ambient IoT device 320. The UE 115 may decode the discovery signal and transmit a response to the ambient IoT device 320 to acknowledge receiving the discovery signal to initiate the association procedure with the ambient IoT device 320. The detailed steps of examples of the ambient IoT device 320 initiating the association procedure with the UE 115 will be further described in FIGS. 5-6.

FIG. 4 is a flow diagram of a communication method 400 according to some aspects of the present disclosure. Aspects of the method 400 may be executed by a computing device (e.g., a processor, processing circuit, and/or other suitable component) of a communication device or other suitable means for performing the actions. For example, a communication device, such as the UE 115 or the UE 700 may utilize one or more components, such as the processor 702, the memory 704, the discovery signal transmission module 708, the transceiver 710, the modem 712, and the one or more antennas 716, to execute aspects of method 400. The method 400 may employ similar mechanisms as in the networks 100 and 200 and the aspects and actions described with respect to FIG. 3. For example, a communication device, such as the ambient IoT device 120 may utilize one or more components, such as the processor 802, the memory 804, the discovery signal transmission module 808, the transceiver 810, the modem 812, and the one or more antennas 816, to execute aspects of method 400. For example, a communication device, such as a network unit 105 may utilize one or more components, such as the processor 902, the memory 904, the discovery signal transmission module 908, the transceiver 910, the modem 912, and the one or more antennas 916, to execute aspects of method 400. As illustrated, the method 400 includes a number of enumerated actions, but the method 400 may include additional actions before, after, and in between the enumerated actions. In some aspects, one or more of the enumerated actions may be omitted or performed in a different order.

At action 402, the UE 115 may transmit a resource indication to a communication device (e.g., a network unit 105 shown as an example in FIG. 4, another UE 115, an internet access backhaul (IAB) node, a repeater node, etc.) for discovery signal transmission. In one embodiment, when the communication device schedules resources for the discovery signal transmission, the resource indication may be an indication to request the communication device to provide a continuous wave in the scheduled resource. For example, the UE 115 may transmit a resource to indicate to the communication device (e.g., a network unit 105, a UE 115, an IAB node, a repeater node, etc.) to indicate which resource the UE 115 will be using for the discovery signal transmission. The communication device may then provide a continuous wave accordingly for the ambient-IoT device 120 to decode the discovery signal from the UE 115. In some aspects, the channel for the discovery signal transmission may be PUSCH or PUCCH when the communication device is a network unit 105. In some aspects, the channel for the discovery signal transmission may be physical sidelink shared channel (PSSCH) when the communication device is another UE 115.

In some aspects, the resource indication may include one bit to legacy downlink control information (DCI) or sidelink control information (SCI), or the resource indication may be transmitted in a new scheduling format, to indicate that the scheduled resource is used for the discovery signal transmission. In another embodiment, when the UE115 selects the resource for the discovery signal transmission, the resource indication from the UE 115 may indicate the communication device to provide continuous wave in the selected resource. The UE 115 may transmit the resource indication via a unicast communication, a groupcast communication, and/or a broadcast communication.

In some aspects, the resource indication may include an indication of one or more target ambient IoT devices 120 that the UE 115 wants to initiate an association with, so that the communication device may assist with discovering the ambient IoT device 120.

At action 404, the communication device may schedule resources for discovery signal transmission upon receiving the resource indication from the UE 115.

As discussed above, in some aspects, when the communication device schedules the resources for the discovery signal transmission, the scheduled resource may be periodically scheduled resources, semi-persistent resources, and/or dynamically scheduled resources. In some aspects, the communication device may schedules the resources as indicated by the UE 115 in the resource indication.

At action 406, the communication device may transmit energy (e.g., sending an energy signal) to the ambient IoT device 120. For example, the communication device may send electromagnetic waves (e.g., radio waves or a single sinewave signal) to the ambient IoT device 120. The ambient IoT device 120 may receive the electromagnetic waves from the communication device at a frequency that matches a resonant frequency of an antenna of the ambient IoT device 120 to induce electric current, such that an integrated circuit of the ambient IoT device 120 may be powered and ready to broadcast its identifier or backscatter a discovery signal from the UE 115.

As discussed above, when the UE 115 indicates a group of target ambient IoT devices for initiating the association procedure at action 402, the communication device may assist with discovering the ambient IoT device 120 by transmitting the energy in a specific energy pattern to indicate the group of target ambient-IoT devices, which can reduce transmission collision.

At action 408, the UE 115 may transmit a discovery signal to initiate an association procedure between the UE 115 and the ambient IoT device 120. As discussed above, the discovery signal may be transmitted in the resources scheduled by the communication device at action 404. In some aspects, the UE 115 may transmit the discovery signal to one or more ambient IoT devices 120. In some aspects, the discovery signal may include a source identifier (ID) associated with the UE 115, a resource allocation for a backscatter signal, an indicator indicating support for receiving the backscatter signal, and/or an indicator indicating support for selection of a backscatter signal frequency by the ambient IoT devices 406. In some aspects, action 406 and action 408 may occur simultaneously.

At action 410, the ambient IoT device 120 may acknowledge receiving the discovery signal from the UE 115 and transmit an acknowledgment to the UE 115. In some aspects, the ambient IoT device 120 may utilize a legacy channel to acknowledge receiving the discovery signal. For example, when the ambient IoT device 120 indicates an ACK/NACK (e.g., an acknowledgement or a negative acknowledgement) in response to the discovery signal, the ambient IoT device 120 may use a physical sidelink feedback channel (PSFCH) to transmit the ACK/NACK. When the ambient IoT device 120 indicates its identifier and an ACK/NACK in response to the discovery signal, the ambient IoT device 120 may use a physical sidelink control channel (PSCCH) and/or a physical sidelink shared channel (PSSCH) to transmit the ACK/NACK and ambient IoT identifier. In this regard, the ambient IoT device 120 may backscatter its identifier to the UE 115 via the resources scheduled at action 404. In some aspects, the ambient IoT device 120 may utilize a new channel to backscatter the discovery signal. For example, the ambient IoT device 120 may have limited capability, the UE 115 or the communication device may introduce a new channel for the ambient IoT device 120 to backscatter ACK/NACK and/or its identifier.

At action 416, the UE 115 may receive the acknowledgement from the ambient IoT device 120 and transmit the identifier of the ambient IoT device 120 to the ambient IoT device 120 to initiate an association procedure between the UE 115 and the ambient IoT device 120.

At action 414, the UE 115 and the ambient IoT device 120 may exchange data during the association. For example, the ambient IoT device 120 may transmit stored data (e.g., serial number of the ambient IoT device 120) to the antenna of the ambient IoT device 120 and then transmit the stored data to the UE 115, and the UE 115 may transmit the stored data of the ambient IoT device 120 to a computer database for a further validation or evaluation. If the UE 115 needs more information when one or more ambient IoT devices 120 responded, the UE 115 may issue another request to the one or more ambient IoT devices 120 for another data exchange (e.g., a command to an ambient IoT device 120 which has a serial number that starts with one to respond).

FIG. 5 is a flow diagram of a communication method 500 according to some aspects of the present disclosure. Aspects of the method 500 may be executed by a computing device (e.g., a processor, processing circuit, and/or other suitable component) of a communication device or other suitable means for performing the actions. For example, a communication device, such as the UE 115 or the UE 700 may utilize one or more components, such as the processor 702, the memory 704, the discovery signal transmission module 708, the transceiver 710, the modem 712, and the one or more antennas 716, to execute aspects of method 500. The method 500 may employ similar mechanisms as in the networks 100 and 200 and the aspects and actions described with respect to FIG. 3. For example, a communication device, such as the ambient IoT device 120 may utilize one or more components, such as the processor 802, the memory 804, the discovery signal transmission module 808, the transceiver 810, the modem 812, and the one or more antennas 816, to execute aspects of method 500. For example, a communication device, such as the network unit 105 may utilize one or more components, such as the processor 902, the memory 904, the discovery signal transmission module 908, the transceiver 910, the modem 912, and the one or more antennas 916, to execute aspects of method 500. As illustrated, the method 500 includes a number of enumerated actions, but the method 500 may include additional actions before, after, and in between the enumerated actions. In some aspects, one or more of the enumerated actions may be omitted or performed in a different order.

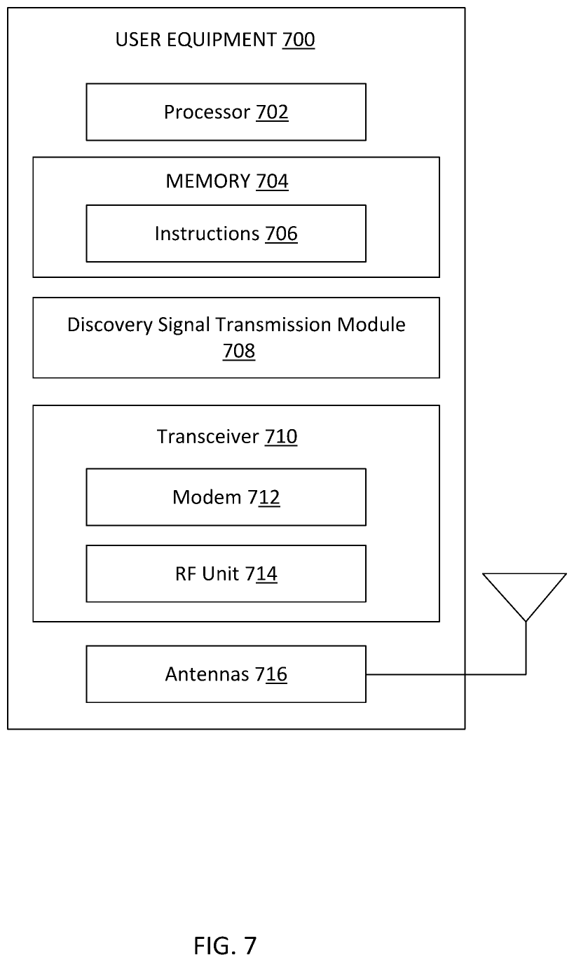

At action 502, a communication device (e.g., a network unit 105 shown as an example in FIG. 5, another UE 115, an internet access backhaul (IAB) node, a repeater node, etc.) may transmit energy (e.g., sending an energy signal) to an ambient IoT device 120. In some aspects, the communication device may schedule resources, that include periodically scheduled resources and/or dynamically scheduled resources, to the ambient IoT device 120 for a communication duration with a UE 115. In some aspects, the UE 115 may be the UE 700 described in FIG. 7. In some aspects, the communication device may indicate the UE 115 scheduled resources for the UE 115 to transmit its response. In some aspects, the communication device may transmit energy to one or more ambient IoT devices 120. When the communication device transmits energy to one or more ambient IoT devices 120, the resources may be divided into one or more time durations and/or frequency areas for the ambient IoT device 120 to randomly select one resource or to select a resource based on a hash of an identifier of the ambient IoT device 120.

At action 504, the ambient IoT device 120 may transmit a discovery signal to initiate an association procedure between the ambient IoT device 120 and the UE 115 in the resources scheduled by the communication device as discussed in the action 502. In some aspects, the association between the ambient IoT device 120 and the UE 115 may follow the air-interface protocols, e.g., International Organization for Standardization (ISO), Electronics Product Code Global Incorporated (EPCglobal), and International Electrotechnical Commission (IEC). The communication between the ambient IoT device 120 and the UE 115 may occur by changing the amplitude of radio waves through Amplitude Shift Keying (ASK). The communication between the ambient IoT device 120 and the UE 115 may not specifically utilize a channel, but operate at at least one of the following frequencies: low frequency (125 MHz to134 kHz), high frequency (13.56 MHz), and ultra-high frequency (856 MHz to 960 MHz).

In some aspects, the ambient IoT device 120 may transmit the discovery signal to one or more UE 115. In some aspects, when the communication device may schedule the resources as discussed in action 502, the ambient IoT device 120 may indicate the UE 115 the scheduled resource for the UE 115 to transmit its response.

At action 506, the UE 115 may acknowledge receiving the discovery signal from the ambient IoT device 120, and transmit an identifier of the UE 115 to the ambient IoT device 120. For example, the UE 115 transmits a response with its device identifier to acknowledge receiving the discovery signal. In some aspects, when the communication device schedules the resources as discussed in action 502 for one or more UEs 115 to transmit the response, a UE 115 may select a resource that is in a different time duration and or in a different frequency areas to transmit the response. For example, the UE 115 may randomly select one resource, select one resource based on a hash of the identifier of the UE 115, and/or sense and select one resource. In some aspects, the UE 115 may transmit the identifier of the UE 115, e.g., a source/destination identifier, via frequency division multiplexing (FDM) or time division multiplexing (TDM).

At action 508, the ambient IoT device 120 may receive the identifier of the UE 115 from the UE 115, and transmit the identifier of the UE 115 back to the UE 115 to initiate the association procedure between the ambient IoT device 120 and the UE 115, e.g., the ambient IoT device 120 backscatters the identifier of the UE 115 to the UE 115.

At action 510, the UE 115 and the ambient IoT device 120 may exchange data during the association. For example, the ambient IoT device 120 may receive a token from the UE 115, and decode an encrypted token (e.g., basic access control) to validate the UE 115.

FIG. 6 is a flow diagram of a communication method 600 according to some aspects of the present disclosure. Aspects of the method 600 may be executed by a computing device (e.g., a processor, processing circuit, and/or other suitable component) of a communication device or other suitable means for performing the actions. For example, a communication device, such as the UE 115 or the UE 700, may utilize one or more components, such as the processor 702, the memory 704, the discovery signal transmission module 708, the transceiver 710, the modem 712, and the one or more antennas 716, to execute aspects of method 600. The method 600 may employ similar mechanisms as in the networks 100 and 200 and the aspects and actions described with respect to FIG. 3. For example, a communication device, such as the ambient IoT device 120, may utilize one or more components, such as the processor 802, the memory 804, the discovery signal transmission module 808, the transceiver 810, the modem 812, and the one or more antennas 816, to execute aspects of method 600. For example, a communication device, such as the network unit 105, may utilize one or more components, such as the processor 902, the memory 904, the discovery signal transmission module 1008, the transceiver 910, the modem 912, and the one or more antennas 916, to execute aspects of method 600. As illustrated, the method 600 includes a number of enumerated actions, but the method 600 may include additional actions before, after, and in between the enumerated actions. In some aspects, one or more of the enumerated actions may be omitted or performed in a different order.

At action 602, the communication device (e.g., a network unit 105 shown as an example in FIG. 6, another UE 115, an internet access backhaul (IAB) node, a repeater node, etc.) may transmit energy signal to the ambient IoT device 120 to the ambient IoT device 120 for a communication duration with the UE 115. In some aspects, the communication device may transmit energy to one or more ambient IoT devices 120.

At action 604, the communication device may transmit a discovery signal resource query associated with the resources for transmitting the discovery signal to the ambient IoT device 120. In some aspects, when the communication device transmits energy to one or more ambient IoT devices 120, the communication device sends a discovery signal resource query to the ambient IoT device 120 and schedules dedicated resource for each ambient-IoT device 120 based on received response from each ambient-IoT device 120 for discovery signal transmission. In some aspects, the discovery signal resource query may be energy-based, payload/sequence-based, and a combination of energy-based and payload/sequence-based.

At action 606, the ambient IoT device 120 may acknowledge the discovery signal resource query received from the communication device, in response to the discovery signal resource query, the ambient IoT device 120 may transmit a request to the communication device indicating selected resources for transmitting the discovery signal. In some aspects, when the ambient IoT device 120 wants to transmit the discovery signal, the ambient IoT device 120 may transmit (e.g., backscatter) an identifier of the ambient IoT device 120 to the communication device.

At action 608, the communication device may acknowledge the request received from the ambient IoT device 120, and may transmit an indicator to the ambient IoT device 120. The indicator may indicate scheduled resources for transmitting the discovery signal.

At action 610, the ambient IoT device 120 may transmit a discovery signal to initiate an association procedure between the ambient IoT device 120 and the UE 115 in the resources scheduled by the communication device as discussed in the action 604. In some aspects, the ambient IoT device 120 may transmit the discovery signal to one or more UE 115. In some aspects, when the communication device schedules the resources as discussed in action 604, the ambient IoT device 120 may indicate the UE 115 the scheduled resource for the UE 115 to transmit its response.

At action 612, the UE 115 may acknowledge receiving the discovery signal from the ambient IoT device 120, and transmit an identifier of the UE 115 to the ambient IoT device 120. For example, the UE 115 transmits a response with its device identifier to acknowledge receiving the discovery signal. In some aspects, when the communication device schedules the resources as discussed in action 604 for one or more UEs 115 to transmit the response, a UE 115 may select a resource that is in a different time duration and or in a different frequency areas to transmit the response. For example, the UE 115 may randomly select one resource, select one resource based on a hash of the identifier of the UE 115, and/or sense and select one resource. In some aspects, the UE 115 may transmit the identifier of the UE 115, e.g., a source/destination identifier, via frequency division multiplexing (FDM) or time division multiplexing (TDM).

At action 614, the ambient IoT device 120 may receive the identifier of the UE 115 from the UE 115, and transmit the identifier of the UE 115 to the UE 115 to initiate the association procedure between the ambient IoT device 120 and the UE 115, e.g., the ambient IoT device 120 backscatters the identifier of the UE 115 to the UE 115.

At action 616, the UE 115 and the ambient IoT device 120 may exchange data during the association. For example, the ambient IoT device 120 may transmit location data or sensor data to the UE 115.

FIG. 7 is a block diagram of an exemplary UE 700 according to some aspects of the present disclosure. The UE 700 may be the UE 115 in the network 100, or 200 as discussed above. As shown, the UE 700 may include a processor 702, a memory 704, a discovery signal transmission module 708, a transceiver 710 including a modem subsystem 712 and a radio frequency (RF) unit 714, and one or more antennas 716. These elements may be coupled with each other and in direct or indirect communication with each other, for example via one or more buses.

The processor 702 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 702 may also be implemented as a combination of computing devices, e.g., a combination of a DSP and a microprocessor, a plurality of microprocessors, one or more microprocessors in conjunction with a DSP core, or any other such configuration.

The memory 704 may include a cache memory (e.g., a cache memory of the processor 702), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In some instances, the memory 704 includes a non-transitory computer-readable medium. The memory 704 may store instructions 706. The instructions 706 may include instructions that, when executed by the processor 702, cause the processor 702 to perform the operations described herein with reference to the UEs 115 in connection with aspects of the present disclosure, for example, aspects of FIGS. 3-6. Instructions 706 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The discovery signal transmission module 708 may be implemented via hardware, software, or combinations thereof. For example, the discovery signal transmission module 708 may be implemented as a processor, circuit, and/or instructions 706 stored in the memory 704 and executed by the processor 702. In some aspects, the discovery signal transmission module 708 may implement the aspects of FIGS. 3-6. For example, the discovery signal transmission module 708 may transmit, to one or more ambient IoT devices in resources scheduled by a wireless communication device, a discovery signal to initiate an association procedure between the first UE and at least one of the one or more ambient IoT devices. The discovery signal transmission module 708 may receive, from the one or more ambient IoT devices in response to the discovery signal, an acknowledgment to initiate the association procedure, wherein the one or more ambient IoT devices are powered by energy transmitted by the wireless communication device.

In some aspects, the discovery signal transmission module 708 may transmit, to one or more ambient Internet of Things (IoT) devices in resources scheduled by a wireless communication device, a discovery signal to initiate an association procedure between the first UE and at least one of the one or more ambient IoT devices. The discovery signal transmission module 708 may receive, from the one or more ambient IoT devices in response to the discovery signal, an acknowledgment to initiate the association procedure, wherein the one or more ambient IoT devices are powered by energy transmitted by the wireless communication device.

As shown, the transceiver 710 may include the modem subsystem 712 and the RF unit 714. The transceiver 710 may be configured to communicate bi-directionally with other devices, such as the BSs 105 and/or the UEs 115. The modem subsystem 712 may be configured to modulate and/or encode the data from the memory 704 and the according to a modulation and coding scheme (MCS), e.g., a low-density parity check (LDPC) coding scheme, a turbo coding scheme, a convolutional coding scheme, a digital beamforming scheme, etc. The RF unit 714 may be configured to process (e.g., perform analog to digital conversion or digital to analog conversion, etc.) modulated/encoded data from the modem subsystem 712 (on outbound transmissions) or of transmissions originating from another source such as a UE 115 or a BS 105. The RF unit 714 may be further configured to perform analog beamforming in conjunction with the digital beamforming. Although shown as integrated together in transceiver 710, the modem subsystem 712 and the RF unit 714 may be separate devices that are coupled together to enable the UE 700 to communicate with other devices.

The RF unit 714 may provide the modulated and/or processed data, e.g. data packets (or, more generally, data messages that may contain one or more data packets and other information), to the antennas 716 for transmission to one or more other devices. The antennas 716 may further receive data messages transmitted from other devices. The antennas 716 may provide the received data messages for processing and/or demodulation at the transceiver 710. The antennas 716 may include multiple antennas of similar or different designs in order to sustain multiple transmission links. The RF unit 714 may configure the antennas 716.

In some instances, the UE 700 may include multiple transceivers 710 implementing different RATs (e.g., NR and LTE). In some instances, the UE 700 may include a single transceiver 710 implementing multiple RATs (e.g., NR and LTE). In some instances, the transceiver 710 may include various components, where different combinations of components may implement RATs.

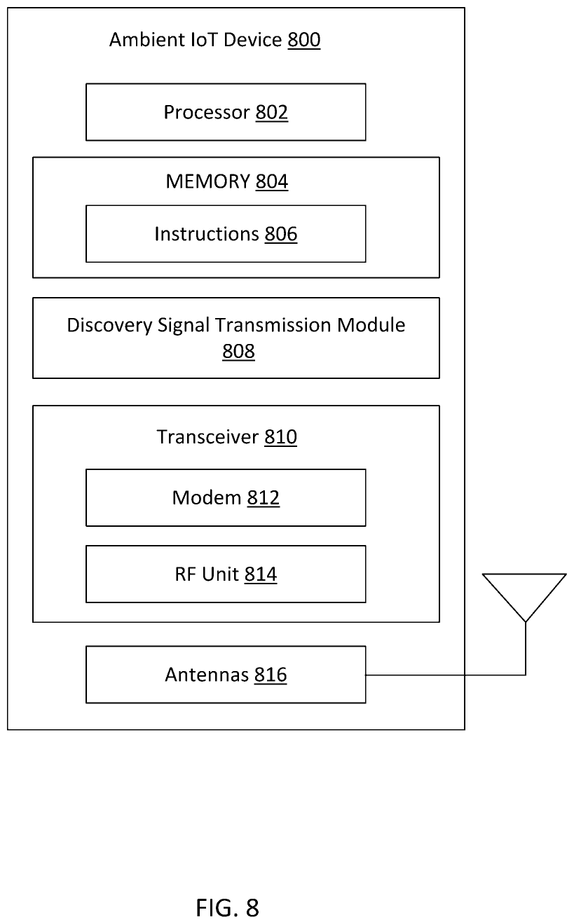

FIG. 8 is a block diagram of an exemplary ambient IoT device 800 according to some aspects of the present disclosure. The ambient IoT device 800 may be the ambient IoT device 120 in the network 100, or 200 as discussed above. As shown, the ambient IoT device 800 may include a processor 802, a memory 804, a discovery signal transmission module 808, a transceiver 810 including a modem subsystem 812 and a radio frequency (RF) unit 814, and one or more antennas 816. These elements may be coupled with each other and in direct or indirect communication with each other, for example via one or more buses.

The processor 802 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 802 may also be implemented as a combination of computing devices, e.g., a combination of a DSP and a microprocessor, a plurality of microprocessors, one or more microprocessors in conjunction with a DSP core, or any other such configuration.

The memory 804 may include a cache memory (e.g., a cache memory of the processor 802), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In some instances, the memory 804 includes a non-transitory computer-readable medium. The memory 804 may store instructions 806. The instructions 806 may include instructions that, when executed by the processor 802, cause the processor 802 to perform the operations described herein with reference to the ambient IoT device 120 in connection with aspects of the present disclosure, for example, aspects of FIGS. 3-6. Instructions 806 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The discovery signal transmission module 808 may be implemented via hardware, software, or combinations thereof. For example, the discovery signal transmission module 808 may be implemented as a processor, circuit, and/or instructions 806 stored in the memory 804 and executed by the processor 802. In some aspects, the discovery signal transmission module 808 may implement the aspects of FIGS. 3-6. For example, the discovery signal transmission module 808 may transmit, to one or more UEs in resources scheduled by a wireless communication device, a discovery signal to initiate an association procedure between the UE and at least one of the one or more ambient IoT devices. The discovery signal transmission module 808 may receive, from the one or more ambient IoT devices in response to the discovery signal, an acknowledgment to initiate the association procedure, wherein the one or more ambient IoT devices are powered by energy transmitted by the wireless communication device.

In some aspects, the discovery signal transmission module 808 may receive, from a wireless communication device, an indicator indicating resources for transmitting a discovery signal, wherein the ambient IoT device is powered by energy transmitted by the wireless communication device. The discovery signal transmission module 808 may transmit, to one or more first UEs in the indicated resources, a discovery signal to initiate an association procedure between the one or more first UEs and the ambient IoT device. The discovery signal transmission module 808 may receive, from at least one of the one or more first UEs in response to the discovery signal, an acknowledgment to initiate the association procedure with the at least one of the one or more first UEs.

As shown, the transceiver 810 may include the modem subsystem 812 and the RF unit 814. The transceiver 810 may be configured to communicate bi-directionally with other devices, such as the BSs 105 and/or the UEs 115. The modem subsystem 812 may be configured to modulate and/or encode the data from the memory 804 and the according to a modulation and coding scheme (MCS), e.g., a low-density parity check (LDPC) coding scheme, a turbo coding scheme, a convolutional coding scheme, a digital beamforming scheme, etc. The RF unit 814 may be configured to process (e.g., perform analog to digital conversion or digital to analog conversion, etc.) modulated/encoded data from the modem subsystem 812 (on outbound transmissions) or of transmissions originating from another source such as a UE 115 or a BS 105. The RF unit 814 may be further configured to perform analog beamforming in conjunction with the digital beamforming. Although shown as integrated together in transceiver 810, the modem subsystem 812 and the RF unit 814 may be separate devices that are coupled together to enable the UE 800 to communicate with other devices.

The RF unit 814 may provide the modulated and/or processed data, e.g. data packets (or, more generally, data messages that may contain one or more data packets and other information), to the antennas 816 for transmission to one or more other devices. The antennas 816 may further receive data messages transmitted from other devices. The antennas 816 may provide the received data messages for processing and/or demodulation at the transceiver 810. The antennas 816 may include multiple antennas of similar or different designs in order to sustain multiple transmission links. The RF unit 814 may configure the antennas 816.

In some instances, the ambient IoT device 800 may include multiple transceivers 810 implementing different RATs (e.g., NR and LTE). In some instances, the ambient IoT device 800 may include a single transceiver 810 implementing multiple RATs (e.g., NR and LTE). In some instances, the transceiver 810 may include various components, where different combinations of components may implement RATs.

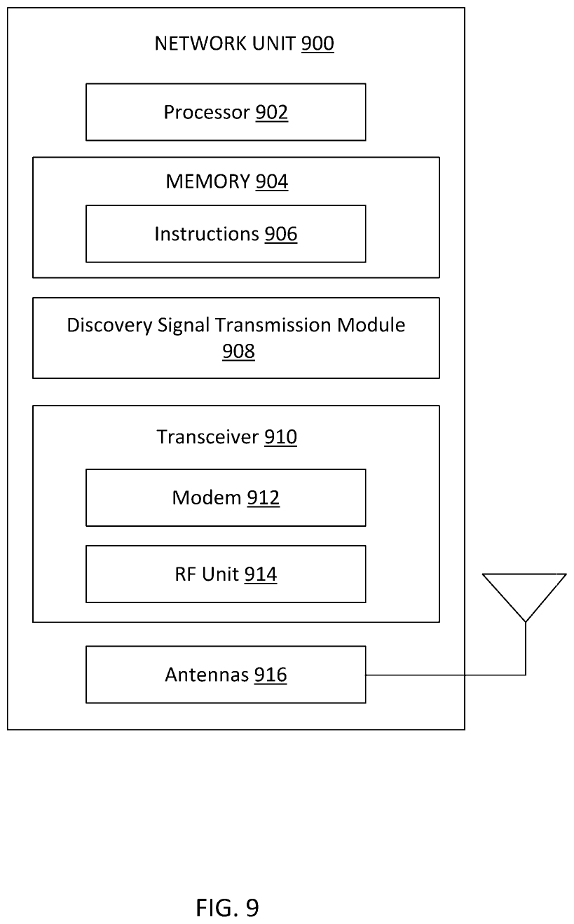

FIG. 9 is a block diagram of an exemplary network unit 900 according to some aspects of the present disclosure. The network unit 900 may be the BS 105, the CU 210, the DU 230, or the RU 240, as discussed above. As shown, the network unit 900 may include a processor 902, a memory 904, a discovery signal transmission module 908, a transceiver 910 including a modem subsystem 912 and a RF unit 914, and one or more antennas 916. These elements may be coupled with each other and in direct or indirect communication with each other, for example via one or more buses.

The processor 902 may have various features as a specific-type processor. For example, these may include a CPU, a DSP, an ASIC, a controller, a FPGA device, another hardware device, a firmware device, or any combination thereof configured to perform the operations described herein. The processor 902 may also be implemented as a combination of computing devices, e.g., a combination of a DSP and a microprocessor, a plurality of microprocessors, one or more microprocessors in conjunction with a DSP core, or any other such configuration.

The memory 904 may include a cache memory (e.g., a cache memory of the processor 902), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some instances, the memory 904 may include a non-transitory computer-readable medium. The memory 904 may store instructions 906. The instructions 906 may include instructions that, when executed by the processor 902, cause the processor 902 to perform operations described herein, for example, aspects of FIGS. 3-6. Instructions 906 may also be referred to as code, which may be interpreted broadly to include any type of computer-readable statement(s).

The discovery signal transmission module 908 may be implemented via hardware, software, or combinations thereof. For example, the discovery signal transmission module 908 may be implemented as a processor, circuit, and/or instructions 906 stored in the memory 904 and executed by the processor 902. In some aspects, the discovery signal transmission module 908 may implement the aspects of FIGS. 3-6. For example, the discovery signal transmission module 908 may transmit, to a first UE, an indicator indicating resources associated with a discovery signal to initiate an association procedure between the first UE and an ambient Internet of Things (IoT) device. The discovery signal transmission module 908 may receive, from the first UE, an indication of one or more selected resources from the resources associated with the discovery signal. The discovery signal transmission module 908 may transmit, to the ambient IoT device, a continuous wave in the one or more selected resources to power the ambient IoT device during the association procedure.

Additionally or alternatively, the discovery signal transmission module 908 may be implemented in any combination of hardware and software, and may, in some implementations, involve, for example, processor 902, memory 904, instructions 906, transceiver 910, and/or modem 912.

As shown, the transceiver 910 may include the modem subsystem 912 and the RF unit 914. The transceiver 910 may be configured to communicate bi-directionally with other devices, such as the UEs 115 and/or UE 800. The modem subsystem 912 may be configured to modulate and/or encode data according to a MCS, e.g., a LDPC coding scheme, a turbo coding scheme, a convolutional coding scheme, a digital beamforming scheme, etc. The RF unit 914 may be configured to process (e.g., perform analog to digital conversion or digital to analog conversion, etc.) modulated/encoded data from the modem subsystem 912 (on outbound transmissions) or of transmissions originating from another source such as a UE 115 or UE 700. The RF unit 914 may be further configured to perform analog beamforming in conjunction with the digital beamforming. Although shown as integrated together in transceiver 910, the modem subsystem 912 and/or the RF unit 914 may be separate devices that are coupled together at the network unit 900 to enable the network unit 900 to communicate with other devices.

The RF unit 914 may provide the modulated and/or processed data, e.g. data packets (or, more generally, data messages that may contain one or more data packets and other information), to the antennas 916 for transmission to one or more other devices. This may include, for example, a configuration indicating a plurality of sub-slots within a slot according to aspects of the present disclosure. The antennas 916 may further receive data messages transmitted from other devices and provide the received data messages for processing and/or demodulation at the transceiver 910. The antennas 916 may include multiple antennas of similar or different designs in order to sustain multiple transmission links.

In some instances, the network unit 900 may include multiple transceivers 910 implementing different RATs (e.g., NR and LTE). In some instances, the network unit 900 may include a single transceiver 910 implementing multiple RATs (e.g., NR and LTE). In some instances, the transceiver 910 may include various components, where different combinations of components may implement RATs.

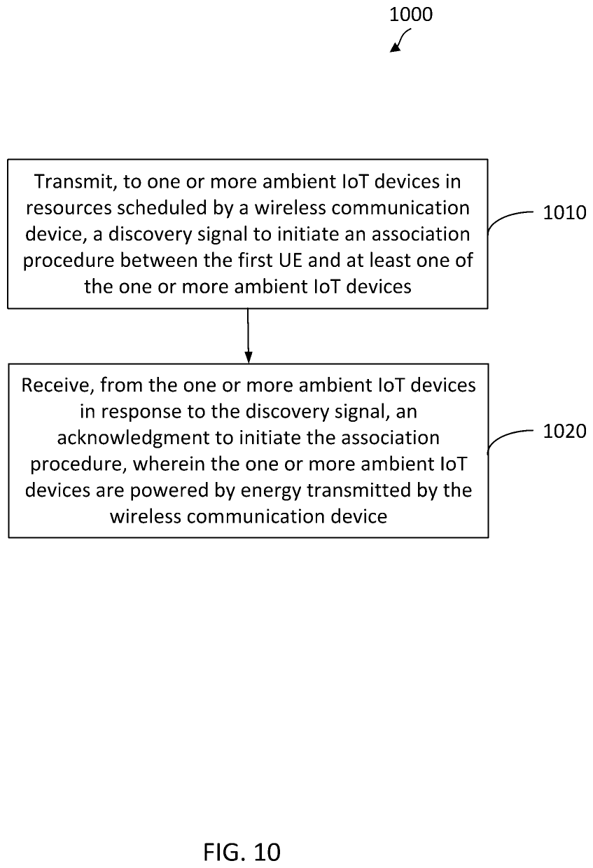

FIG. 10 is a flow diagram of a communication method 1000 according to some aspects of the present disclosure. Aspects of the method 1000 can be executed by a computing device (e.g., a processor, processing circuit, and/or other suitable component) of a wireless communication device or other suitable means for performing the actions. For example, a wireless communication device, such as the UE 105 or the UE 700, may utilize one or more components, such as the processor 702, the memory 704, the discovery signal transmission module 708, the transceiver 710, the modem 712, and the one or more antennas 716, to execute aspects of method 1000. The method 1000 may employ similar mechanisms as in the networks 100 and 200 and the aspects and actions described with respect to FIGS. 3-6. As illustrated, the method 1000 includes a number of enumerated actions, but the method 1000 may include additional actions before, after, and in between the enumerated actions. In some aspects, one or more of the enumerated actions may be omitted or performed in a different order.

At action 1010, the method 1000 includes a first user equipment transmitting, to one or more ambient IoT devices in resources scheduled by a wireless communication device (e.g., the UE 115, the UE 700, the network unit 900, the BS 105, the RU 240, the DU 230, and/or the CU 210), a discovery signal to initiate an association procedure between the first UE and at least one of the one or more ambient IoT devices.

In some aspects, the method 1000 may include the first UE transmitting, to the wireless communication device, an indication indicating at least one target ambient IoT device for initiating the association procedure. The ambient IoT devices may include the target ambient IoT device. The method 1000 may include the first UE receiving the acknowledgement from the target ambient IoT device to initiate the association procedure.

In some aspects, the first UE may transmit, to the wireless communication device, a request for the wireless communication device to power the ambient IoT device via a continuous wave transmission to the ambient IoT device. In this regard, the request may be transmitted via a unicast communication, a groupcast communication, and/or a broadcast communication.

In some aspects, the method 1000 may include the first UE determining the resources to be used in transmitting the discovery signal, and transmitting, to the wireless communication device, an indicator indicating the resources to be used in transmitting the discovery signal.

In some aspects, the wireless communication device may include a wireless communication device or a second UE. In some aspects, the resources may include at least one of periodically scheduled, semi-persistent, or dynamically scheduled resources. In some aspects, the discovery signal may include at least one of a source identifier (ID) associated with the first UE, a resource allocation for a backscatter signal, an indicator indicating support for receiving the backscatter signal, or an indicator indicating support for selection of a backscatter signal frequency by the one or more ambient IoT devices.

At action 1020, the method 1000 includes the first user equipment receiving, from the ambient IoT devices in response to the discovery signal, an acknowledgment to initiate the association procedure, wherein the ambient IoT devices are powered by energy transmitted by the wireless communication device. In this regard, the method 1000 may include the first UE transmitting, to at least one of the ambient IoT devices in response to receiving the acknowledgment, an identifier of the ambient IoT device. After the association is initiated, the method 1000 may include data transmission between the first user equipment and the ambient IoT device, e.g., sensor data of an environment near the ambient IoT device.

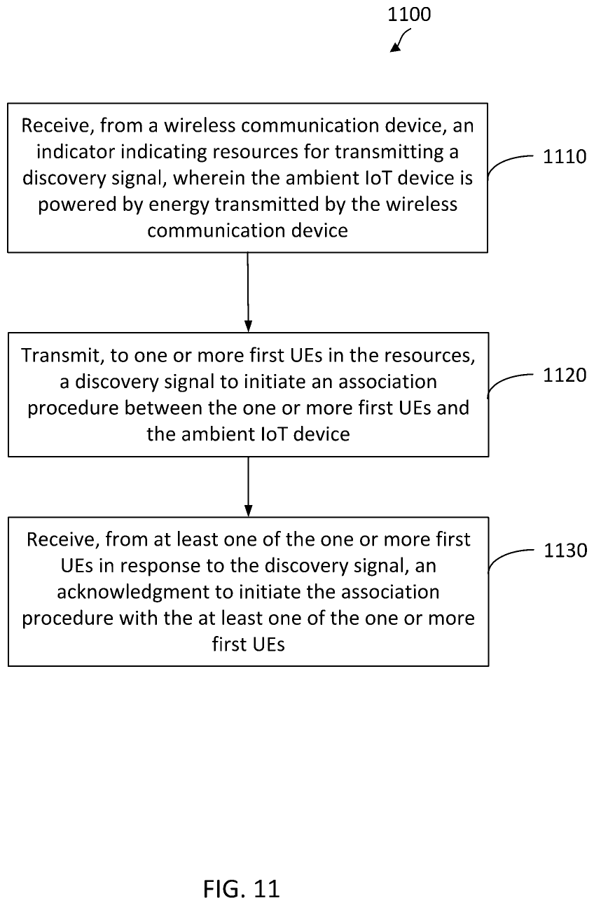

FIG. 11 is a flow diagram of a communication method 1100 according to some aspects of the present disclosure. Aspects of the method 1100 can be executed by a computing device (e.g., a processor, processing circuit, and/or other suitable component) of a wireless communication device or other suitable means for performing the actions. For example, a wireless communication device, such as the ambient IoT device 120, may utilize one or more components, such as the processor 802, the memory 804, the discovery signal transmission module 808, the transceiver 810, the modem 812, and the one or more antennas 716, to execute aspects of method 1100. The method 1100 may employ similar mechanisms as in the networks 100 and 200 and the aspects and actions described with respect to FIGS. 3-6. As illustrated, the method 1100 includes a number of enumerated actions, but the method 1100 may include additional actions before, after, and in between the enumerated actions. In some aspects, one or more of the enumerated actions may be omitted or performed in a different order.

At action 1110, the method 1100 may include an ambient IoT device receiving, from a wireless communication device (e.g., the UE 115, the UE 700, the wireless communication device 900, the BS 105, the RU 240, the DU 230, and/or the CU 210), an indicator indicating resources for transmitting a discovery signal. The ambient IoT device is powered by energy transmitted by the wireless communication device. In some aspects, the wireless communication device may include a wireless communication device or a second UE.

In some aspects, the method 1100 may include the ambient IoT device receiving, from the wireless communication device, an indicator indicating available resources for transmitting the discovery signal, and transmitting, to the wireless communication device in response to the indicator indicating the available resources, a response indicating a selected resource from the available resources. In this regard, the selected resource may be selected at least randomly or via a hash based on an identifier of the ambient IoT device.

In some aspects, the method 1100 may include the ambient IoT device receiving, from the wireless communication device, a resource query associated with the resources for transmitting the discovery signal, and transmitting, to the wireless communication device in response to the resource query, a request for dedicated resources from the resources for transmitting the discovery signal. In this regard, the resource query may include an energy-based query or a sequence-based query.

In some aspects, the discovery signal may include at least one of a source identifier (ID) associated with the first UE, a resource allocation for a backscatter signal, an indicator indicating support for receiving the backscatter signal, or an indicator indicating support for selection of a backscatter signal frequency by the one or more ambient IoT devices.

At action 1120, the method 1100 includes the ambient IoT device transmitting, to one or more first UEs in the resources, a discovery signal to initiate an association procedure between the one or more first UEs and the ambient IoT device.

At action 1120, the method 1100 includes the ambient IoT device receiving, from the first UEs in response to the discovery signal, an acknowledgment to initiate the association procedure with at least one of the first UEs. In this regard, the acknowledgement may include an identifier of the first UEs, and the acknowledgement may be received via an allocated resource selected by each of the first UEs. After the association is initiated, the method 1100 may include data transmission between the first user equipment and the ambient IoT device, e.g., location data of a product which is installed with the ambient IoT device.

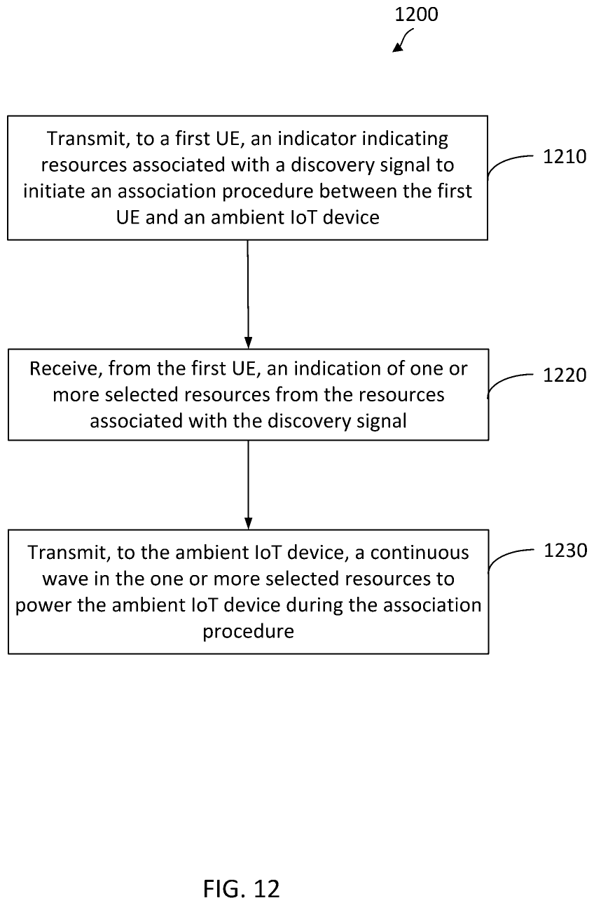

FIG. 12 is a flow diagram of a communication method 1200 according to some aspects of the present disclosure. Aspects of the method 1200 can be executed by a computing device (e.g., a processor, processing circuit, and/or other suitable component) of a wireless communication device or other suitable means for performing the actions. For example, a wireless communication device, such as the UE 115 or the UE 700, may utilize one or more components, such as the processor 702, the memory 704, the discovery signal transmission module 708, the transceiver 710, the modem 712, and the one or more antennas 716, to execute aspects of method 1200. For example, a wireless communication device, such as the wireless communication device (e.g., the network unit 900, the BS 105, the RU 240, the DU 230, and/or the CU 210) may utilize one or more components, such as the processor 902, the memory 904, the discovery signal transmission module 908, the transceiver 910, the modem 912, and the one or more antennas 916, to execute aspects of method 1200. The method 1200 may employ similar mechanisms as in the networks 100 and 200 and the aspects and actions described with respect to FIGS. 3-6. As illustrated, the method 1200 includes a number of enumerated actions, but the method 1200 may include additional actions before, after, and in between the enumerated actions. In some aspects, one or more of the enumerated actions may be omitted or performed in a different order.

At action 1210, the method 1200 includes a wireless communication device (e.g., the UE 115, the UE 700, the network unit 900, the BS 105, the RU 240, the DU 230, and/or the CU 210) transmitting, to a first UE, an indicator indicating resources associated with a discovery signal to initiate an association procedure between the first UE and an ambient IoT device. In this regard, the wireless communication device may receive, from the first UE, an indicator of at least one target ambient IoT device. In some aspects, the wireless communication device may include a network unit or a second UE.

In some aspects, the indicator may be transmitted in a codepoint via downlink control information (DCI) and/or sidelink control information (SCI). In this regard, the indicator may indicate the wireless communication device will transmit the continuous wave in the selected resources.

At action 1220, the method 1200 includes the wireless communication device receiving, from the first UE, an indication of one or more selected resources from the resources associated with the discovery signal.

At action 1230, the method 1200 includes the wireless communication device transmitting, to the ambient IoT device, a continuous wave in the one or more selected resources to power the ambient IoT device during the association procedure. After the association is initiated, the method 1200 may include data transmission between the first user equipment and the ambient IoT device, e.g., a serial number of the ambient IoT device.

Further aspects of the present disclosure include the following:

Aspect 1 includes a method of wireless communication performed by a first user equipment (UE), the method comprising transmitting, to one or more ambient Internet of Things (IoT) devices in resources scheduled by a wireless communication device, a discovery signal to initiate an association procedure between the first UE and at least one of the one or more ambient IoT devices; and receiving, from the one or more ambient IoT devices in response to the discovery signal, an acknowledgment to initiate the association procedure, wherein the one or more ambient IoT devices are powered by energy transmitted by the wireless communication device.

Aspect 2 includes the method of aspect 1, wherein the wireless communication device comprises at least one of a network unit or a second UE.

Aspect 3 includes the method of any of aspects 1-2, wherein the discovery signal comprises at least one of a source identifier (ID) associated with the first UE, a resource allocation for a backscatter signal, an indicator indicating support for receiving the backscatter signal, or an indicator indicating support for selection of a backscatter signal frequency by the one or more ambient IoT devices.

Aspect 4 includes the method of any of aspects 1-3, further comprising transmitting, to the wireless communication device, an indication indicating at least one target ambient IoT device for initiating the association procedure, wherein the one or more ambient IoT devices comprise the at least one target ambient IoT device; and receiving the acknowledgment from the at least one target ambient IoT device.

Aspect 5 includes the method of any of aspects 1-4, further comprising transmitting, to at least one of the one or more ambient IoT devices in response to receiving the acknowledgment, an identifier of the at least one of the one or more ambient IoT devices.

Aspect 6 includes the method of any of aspects 1-5, wherein the resources comprise at least one of periodically scheduled, semi-persistent, or dynamically scheduled resources.

Aspect 7 includes the method of any of aspects 1-6, further comprising transmitting, to the wireless communication device, a request for the wireless communication device to power the ambient IoT device via a continuous wave transmission to the ambient IoT device.

Aspect 8 includes the method of any of aspects 1-7, wherein the transmitting the request comprises transmitting the request via at least one of a unicast communication, a groupcast communication, or a broadcast communication.

Aspect 9 includes the method of any of aspects 1-8, further comprising determining the resources to be used in transmitting the discovery signal; and transmitting, to the wireless communication device, an indicator indicating the resources to be used in transmitting the discovery signal.

Aspect 10 includes a method of wireless communication performed by an ambient Internet of Things (IoT) device, the method comprising receiving, from a wireless communication device, an indicator indicating resources for transmitting a discovery signal, wherein the ambient IoT device is powered by energy transmitted by the wireless communication device; transmitting, to one or more first user equipments (UEs) in the resources, a discovery signal to initiate an association procedure between the one or more first UEs and the ambient IoT device; and receiving, from at least one of the one or more first UEs in response to the discovery signal, an acknowledgment to initiate the association procedure with the at least one of the one or more first UEs.

Aspect 11 includes the method of aspect 10, wherein the wireless communication device comprises at least one of a network unit or a second UE.

Aspect 12 includes the method of any of aspects 10-11, wherein the resources comprise at least one of periodically scheduled resources or dynamically scheduled resources.

Aspect 13 includes the method of any of aspects 10-12, further comprising receiving, from the wireless communication device, a resource query associated with the resources for transmitting the discovery signal; and transmitting, to the wireless communication device in response to the resource query, a request for dedicated resources for transmitting the discovery signal, wherein the resources comprise the dedicated resources.

Aspect 14 includes the method of any of aspects 10-13, wherein the resource query comprises at least one of an energy-based query and/or a sequence-based query.

Aspect 15 includes the method of any of aspects 10-14, further comprising receiving, from the wireless communication device, an indicator indicating available resources for transmitting the discovery signal; and transmitting, to the wireless communication device in response to the indicator indicating the available resources, a response indicating a selected resource from the available resources, wherein the resources comprise the selected resource.

Aspect 16 includes the method of any of aspects 10-15, wherein the selected resource is selected randomly.

Aspect 17 includes the method of any of aspects 10-16, wherein the selected resource is selected via a hash based on an identifier of the ambient IoT device.

Aspect 18 includes the method of any of aspects 10-17, wherein the acknowledgement comprises an identifier of the at least one of the one or more first UEs.

Aspect 19 includes the method of any of aspects 10-18, wherein the acknowledgement is received via an allocated resource selected by the at least one of the one or more first UEs.

Aspect 20 includes a method of wireless communication performed by a wireless communication device, the method comprising transmitting, to a first user equipment (UE), an indicator indicating resources associated with a discovery signal to initiate an association procedure between the first UE and an ambient Internet of Things (IoT) device; receiving, from the first UE, an indication of one or more selected resources from the resources associated with the discovery signal; and transmitting, to the ambient IoT device, a continuous wave in the one or more selected resources to power the ambient IoT device during the association procedure.

Aspect 21 includes the method of aspect 20, wherein the wireless communication device comprises at least one of a network unit or a second UE.

Aspect 22 includes the method of any of aspects 20-21, further comprising receiving, from the first UE, an indicator of at least one target ambient IoT device, wherein the at least one target ambient IoT device includes the ambient IoT device.

Aspect 23 includes the method of any of aspects 20-22, wherein the transmitting the indicator comprises transmitting the indicator in a codepoint via at least one of downlink control information (DCI) or sidelink control information (SCI), wherein the indicator further indicates the wireless communication device will transmit the continuous wave in the one or more selected resources.

Aspect 24 includes a first user equipment (UE) comprising at least one memory; at least one transceiver; and at least one processor in communication with the at least one memory and the at least one transceiver, wherein the first UE is configured to perform any one or more of aspects 1-9.

Aspect 25 includes an ambient Internet of Things (IoT) device comprising at least one memory; at least one transceiver; and at least one processor in communication with the at least one memory and the at least one transceiver, wherein the ambient IoT device is configured to perform any one or more of aspects 10-19.

Aspect 26 includes a wireless communication device comprising at least one memory; at least one transceiver; and at least one processor in communication with the at least one memory and the at least one transceiver, wherein the wireless communication device is configured to perform any one or more of aspects 20-23.

Aspect 27. A user equipment (UE) comprising one or more means to perform any one or more of aspects 1-9.

Aspect 28. An ambient Internet of Things (IoT) device comprising one or more means to perform any one or more of aspects 10-19.

Aspect 29. A wireless communication device comprising one or more means to perform any one or more of aspects 20-23.

Aspect 30. A non-transitory computer-readable medium storing one or more instructions for wireless communication, the one or more instructions comprising one or more instructions that, when executed by one or more processors of a user equipment (UE), cause the UE to perform any one or more of aspects 1-9.

Aspect 31. A non-transitory computer-readable medium storing one or more instructions for wireless communication, the one or more instructions comprising one or more instructions that, when executed by one or more processors of an ambient Internet of Things (IoT) device, cause the ambient IoT device to perform any one or more of aspects 10-19.

Aspect 32. A non-transitory computer-readable medium storing one or more instructions for wireless communication, the one or more instructions comprising one or more instructions that, when executed by one or more processors of a wireless communication device, cause the wireless communication device to perform any one or more of aspects 20-23.

Aspect 33. A method, device, apparatus, computer program product, non-transitory computer-readable medium, user equipment, base station, network entity, network node, wireless communication device, and/or processing system in accordance with one or more of aspects 1-23 and/or as described herein with reference to the accompanying detailed description and/or drawings.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations may be made in and to the materials, apparatus, configurations and methods of use of the devices of the present disclosure without departing from the spirit and scope thereof. In light of this, the scope of the present disclosure should not be limited to that of the particular instances illustrated and described herein, as they are merely by way of some examples thereof, but rather, should be fully commensurate with that of the claims appended hereafter and their functional equivalents.

1. A method of wireless communication performed by a first user equipment (UE), the method comprising:
transmitting, to one or more ambient Internet of Things (IoT) devices in resources scheduled by a wireless communication device, a discovery signal to initiate an association procedure between the first UE and at least one of the one or more ambient IoT devices; and
receiving, from the one or more ambient IoT devices in response to the discovery signal, an acknowledgment to initiate the association procedure, wherein the one or more ambient IoT devices are powered by energy transmitted by the wireless communication device.

2. The method of claim 1, wherein the discovery signal comprises at least one of a source identifier (ID) associated with the first UE, a resource allocation for a backscatter signal, an indicator indicating support for receiving the backscatter signal, or an indicator indicating support for selection of a backscatter signal frequency by the one or more ambient IoT devices.

3. The method of claim 1, further comprising:
transmitting, to the wireless communication device, an indication indicating at least one target ambient IoT device for initiating the association procedure, wherein the one or more ambient IoT devices comprise the at least one target ambient IoT device; and
receiving the acknowledgment from the at least one target ambient IoT device.

4. The method of claim 1, further comprising:
transmitting, to at least one of the one or more ambient IoT devices in response to receiving the acknowledgment, an identifier of the at least one of the one or more ambient IoT devices.

5. The method of claim 1, wherein the resources comprise at least one of periodically scheduled, semi-persistent, or dynamically scheduled resources.

6. The method of claim 1, further comprising:
transmitting, to the wireless communication device, a request for the wireless communication device to power the one or more ambient IoT devices via a continuous wave transmission to the one or more ambient IoT devices.

7. (canceled)

8. The method of claim 1, further comprising:
determining the resources to be used in transmitting the discovery signal; and
transmitting, to the wireless communication device, an indicator indicating the resources to be used in transmitting the discovery signal.

9-15. (canceled)

16. A first user equipment (UE) comprising:
at least one memory;
at least one transceiver; and
at least one processor in communication with the at least one memory and the at least one transceiver, wherein the first UE is configured to:
transmit, to one or more ambient Internet of Things (IoT) devices in resources scheduled by a wireless communication device, a discovery signal to initiate an association procedure between the first UE and at least one of the one or more ambient IoT devices; and
receive, from the one or more ambient IoT devices in response to the discovery signal, an acknowledgment to initiate the association procedure, wherein the one or more ambient IoT devices are powered by energy transmitted by the wireless communication device.

17. The first UE of claim 16, wherein the discovery signal comprises at least one of a source identifier (ID) associated with the first UE, a resource allocation for a backscatter signal, an indicator indicating support for receiving the backscatter signal, or an indicator indicating support for selection of a backscatter signal frequency by the one or more ambient IoT devices.

18. The first UE of claim 16, wherein the first UE is further configured to:
transmit, to the wireless communication device, an indication indicating at least one target ambient IoT device for initiating the association procedure, wherein the one or more ambient IoT devices comprise the at least one target ambient IoT device; and
receive the acknowledgement from the at least one target ambient IoT device.

19. The first UE of claim 16, wherein the first UE is further configured to:
transmit, to at least one of the one or more ambient IoT devices in response to receiving the acknowledgment, an identifier of the at least one of the one or more ambient IoT devices.

20. (canceled)

21. The first UE of claim 16, wherein the first UE is further configured to:
transmitting, to the wireless communication device, a request for the wireless communication device to power the one or more ambient IoT devices via a continuous wave transmission to the one or more ambient IoT devices.

22. (canceled)

23. The first UE of claim 16, wherein the first UE is further configured to:
determine the resources to be used in transmitting the discovery signal; and
transmit, to the wireless communication device, an indicator indicating the resources to be used in transmitting the discovery signal.

24. An ambient Internet of Things (IoT) device comprising:
at least one memory;
at least one transceiver; and
at least one processor in communication with the at least one memory and the at least one transceiver, wherein the ambient IoT device is configured to:
receive, from a wireless communication device, an indicator indicating resources for transmitting a discovery signal, wherein the ambient IoT device is powered by energy transmitted by the wireless communication device;
transmit, to one or more first UEs in the indicated resources, a discovery signal to initiate an association procedure between the one or more first UEs and the ambient IoT device; and
receive, from at least one of the one or more first UEs in response to the discovery signal, an acknowledgment to initiate the association procedure with the at least one of the one or more first UEs.

25. The ambient IoT device of claim 24, wherein the resources comprise at least one of periodically scheduled resources and dynamically scheduled resources.

26. The ambient IoT device of claim 24, wherein the ambient IoT device is further configured to:
receive, from the wireless communication device, a resource query associated with the resources for transmitting the discovery signal; and
transmit, to the wireless communication device in response to the resource query, a request for dedicated resources for transmitting the discovery signal, wherein the resources comprise the dedicated resources.

27. The ambient IoT device of claim 26, wherein the resource query comprises at least one of an energy-based query or a sequence-based query.

28. The ambient IoT device of claim 24, wherein the ambient IoT device is further configured to:
receive, from the wireless communication device, an indicator indicating available resources for transmitting the discovery signal; and
transmit, to the wireless communication device in response to the indicator indicating the available resources, a response indicating a selected resource from the available resources, wherein the resources comprise the selected resource.

29. The ambient IoT device of claim 28, wherein the selected resource is selected randomly or via a hash based on an identifier of the ambient IoT device.

30. The ambient IoT device of claim 24, wherein the acknowledgement comprises an identifier of the at least one of the one or more first UEs, and is received via an allocated resource selected by the at least one of the one or more first UEs.
